(19) United States
(12) Patent Application Publication
(10) Pub. No.: US 2015/0337574 A1
(43) Pub. Date: Nov. 26, 2015

(54) Deadlock for a door leaf of a door as well as mounting method

(71) Applicant: DORMA Deutschland GmbH, Ennepetal (DE)

(72) Inventor: Hans-Rainer SPECKAMP, Ennepetal (DE)

(21) Appl. No.: 14/715,135

(22) Filed: May 18, 2015

(30) Foreign Application Priority Data
May 22, 2014 (DE) 102014107201.4

(51) Int. Cl. E05C 1/02

(52) U.S. Cl. CPC E05C 1/02

(57) ABSTRACT

The invention relates to a deadlock for a door leaf of a door, in particular to an all-glass door, including a housing, a dead bolt and dead bolt mechanics for moving the dead bolt between an opened position, in which the dead bolt is essentially disposed inside the housing, and at least one locking position, in which the dead bolt is at least partially disposed outside the housing. Furthermore, the invention relates to a mounting method for an attaching disposition of a deadlock in a centered or at least essentially centered manner at a long side of a door leaf of a door.

### CROSS SECTION TO RELATED APPLICATION

This application is related to and claims the benefit of German Patent Application Number 102014107201.4 filed on 22 May 2014, the contents of which are herein incorporated by reference in their entirety.

### TECHNICAL FIELD

The present invention relates to a deadlock for a door leaf of a door, in particular to an all-glass door, including a housing, a dead bolt and dead bolt mechanics for moving the dead bolt between an opened position, in which the dead bolt is essentially disposed inside the housing, and at least one locking position, in which the dead bolt is at least partially disposed outside the housing. Moreover, the invention relates to a mounting method for an attaching disposition of a deadlock in a centered or at least essentially centered manner at a long side of a door leaf of a door.

### BACKGROUND

Basically, it is known to lock doors by means of locks which are disposed at a door leaf of the door. In this case, for example latch bolt locks may be provided, in which a latch bolt is provided in the lock, which latch bolt allows for locking a door by engaging in a latch bolt reception of a counterpart, for example in the door frame. However, said latch bolt locks are disadvantageous in that an abutment is required for the door leaf in order to guarantee a reliable locking of the door. On its own the latch bolt of the latch bolt lock is not sufficient to reliably retain a door in the locked condition. For example, such latch bolt locks are not suitable for double-action doors. In addition or as an alternative, deadlocks are known. In particular, in deadlocks a dead bolt is provided, which can be moved between an opened position and a locking position. In the locking position the dead bolt likewise engages in a reception of a counter-part; however, unlike a latch bolt, due to the positive connection, a dead bolt is able to reliably keep the door in a closed position. Thus, such a deadlock is also usable with double-action doors.

In particular, all-glass doors very often do not include a latch bolt lock, and, in particular very often provided in the shape of double-action doors, they are equipped with push-handles for a user to actuate the door. For locking such a door, deadlocks are known, which according to the state-of-the-art, are provided as a lock insert in corner fittings of the door, respectively in door rails in the door frame. Such locks according to the state-of-the-art are disadvantageous in that they are difficult to access. This is particularly due to the fact, that the known locks are mostly disposed at the top and/or bottom border of the door, respectively of the door frame.

### BRIEF SUMMARY

Therefore, the invention at least partially eliminates the above disadvantages of deadlocks, respectively of mounting methods for deadlocks. In particular, the invention provides a deadlock as well as a mounting method for a deadlock in which, in a simple and inexpensive manner, a particularly easy access and operability of such deadlocks can be ensured.

This problem is solved with a deadlock for a door leaf of a door as well as with a mounting method for an attaching disposition of a deadlock as described herein. In this case, features and details, described in conjunction with the inventive deadlock, are obviously also valid in conjunction with the inventive mounting method and respectively vice versa, such that mutual reference is made, respectively can be made with respect to the disclosure of individual aspects of the invention.

In a first aspect of the invention, the problem is solved with a deadlock for a door leaf of a door, in particular for an all-glass door, including a housing, a dead bolt and dead bolt mechanics for moving the dead bolt between an opened position, in which the dead bolt is essentially disposed inside the housing, and at least one locking position, in which the dead bolt is at least partially disposed outside the housing. The inventive deadlock is characterized in that the deadlock includes a mounting interface, wherein the mounting interface is configured for an attaching disposition of the deadlock in a centered or at least an essentially centered manner at a long side of the door leaf and in that the deadlock includes a torque-proof handle reception for a handle. An inventive deadlock thus includes a dead bolt, which, like in known deadlocks, can be moved between an opened position and a locking position. In this case, in particular also multiple locking positions, which differ in particular in the extension of the dead bolt out of the housing, can be provided. In this way it is differentiated between single-throw deadlocks, in which the dead bolt can be brought into a locking position, and double-throw deadlocks, in which the dead bolt can be brought into two locking positions. In this case, in a double-throw deadlock, in its second locking position, the dead bolt protrudes further from the housing of the deadlock than in its first dead bolt position. All embodiments have a common advantage in this case in that the dead bolt is configured for engaging in a dead bolt reception of a counter-part, to ensure the reliable locking of the door by means of an at least partial form closure, and in that the dead bolt in the opened position, is disposed as far inside the housing of the deadlock that no positive engagement of the dead bolt in the dead bolt reception of the counter part is given. In this case, the dead bolt may be completely disposed inside the housing, however, it may likewise partially protrude from the latter. Also, the dead bolt and the dead bolt reception of a counterpart may have some play with regard to each other. In an inventive deadlock, it is essential to the invention that the deadlock includes a mounting interface. Said mounting interface allows for the deadlock to be disposed in a centered or at least essentially centered manner at a long side of a door leaf. In this case, in the installed condition, the housing of the deadlock is preferably firmly connected to the mounting interface, in particular non-positively and/or positively connected, and particularly preferred it is screwed. In this case, the long side of the door refers to the edge of the door, which extends from the bottom to the top. Preferably, this can be the edge of that long side of the door leaf at which the door hinges are not disposed. With the possibility of disposing the deadlock in a centered or at least essentially centered manner at this long side of the door leaf, which possibility is offered by the mounting interface, an improvement in accessibility of the deadlock is achieved. A user of the deadlock is able to operate the latter in an upright position, bending down or stretching up, like is required with the deadlock in the state-of-the-art, can be foregone. By utilizing a deadlock, it is furthermore possible to lock double-action doors as well, which is impossible with the use of a latch bolt lock. This is in particular made possible because deadlocks to not require an abutment, which would limit the rotation of a door in one direction. Furthermore, in an inventive deadlock, it is essential to the invention that the deadlock has a torque-proof handle reception for a handle. In this case, the handle reception may be an integral part of the mounting interface and/or of the housing of the deadlock. Such a handle reception may likewise particularly and preferably comprises a torque-proof square reception. Such a square reception allows for an arrangement for standardized handles, known in the state-of-the-art and commonly available. Such a handle reception allows for disposing a handle at the deadlock. For opening, respectively for closing the door, a user may grasp said handle and, by means of the handle, can transfer force for opening, respectively for closing the door. Thereby, contact with the door, in particular with all-glass doors, can be eliminated. All in all, an inventive deadlock simplifies locking and actuating a door, in particular an all-glass door, and facilitates the operation for the user.

Furthermore, in an inventive deadlock it can be intended that the mounting interface for an attaching disposition of the deadlock is configured with a maximum of one through-opening in the door leaf. This means in particular, due to the mounting interface, an inventive deadlock can be disposed at doors which only have one or else no through-opening at all in the door leaf. Thus, for example in a deadlock, the locking function thereof being intended to be accessible only from one side, through-holes in a door leaf of the door, can be completely foregone. Such a deadlock may be attached to the door for example by means of non-positive closure and/or closure by adhesive force. A single through-bore may be required in case the locking function of a deadlock is to be accessible from both sides and therefore an access to the locking cylinder is necessary on both sides of the door. However, even in this case, a single through-bore is sufficient, more through-bore in excess are not required. In particular with all-glass doors, the machining of which proves to be more difficult than for example lumber doors, this circumstance makes it considerably easier to equip doors with a deadlock.

An inventive deadlock may be further developed in that the housing of the deadlock has one locking side, wherein the locking side presents a single functional opening, and wherein the dead bolt, when being moved between its opened position and its at least one locking position, is movable through the functional opening. In this case, the locking side is in particular the side of the housing which can be disposed in a preferred manner terminating with the long side of the door leaf of the door. On account of the single functional opening in this locking side, the locking function of the deadlock can be provided by means of the dead bolt. In this case, the functional opening can be obviously adapted to the dead bolt size. It is particularly preferred, if the functional opening is slightly larger than the dead bolt, in order not to impede the movement of the dead bolt, while avoiding in addition penetration of dirt into the inside of the deadlock. Obviously, other openings, also in the locking side of the housing, such as receptions for the attachment elements such as screws or the like, do not represent functional openings according to the invention. A functional opening in the sense of the invention allows for executing the functioning of the deadlock, i. e. in particular moving the dead bolt from its opened position into its at least one locking position. In this case, it is essential to the invention that only a single functional opening be provided in the locking side, through which opening the dead bolt can be moved. In particular there is no functional opening provided in the locking side for a latch bolt. The inventive deadlock thus represents a pure deadlock and therefore has a particularly simple structure. Complicated mechanics, such as necessary for example for a deadlock, can therefore be omitted.

According to a preferred further development of an inventive deadlock, it may be furthermore intended that the functional opening for an arrangement option, independently of the door type, of the deadlock be disposed centrally in the locking side. In this case, centrally is to be understood as a central arrangement of the functional opening in the locking side with regard to the extension of the deadlock along the long side of the door leaf. Thereby, it is in particular possible to utilize an inventive deadlock at both left-closing and right-closing doors, and at both the pull-side and the push-side. The different mounting types do not require different embodiments of an inventive deadlock, whereby producing an inventive deadlock in large numbers at correspondingly low cost per piece is possible.

In an inventive deadlock, it may be particularly and preferably intended that the handle reception includes at least one support surface for the handle to transfer a mechanical force from the handle to the deadlock, and in particular wherein the handle reception, preferably the at least one support surface of the handle reception, extends over the entire or at least essentially over the entire depth of the housing of the deadlock. The force the user exerts onto the handle needs to be transferred onto the door. With the at least one support surface of the handle reception, said force is particularly effectively transferred from the handle onto the deadlock and from the latter onto the door. The preferred extension of the support surface over the entire or at least over essentially the entire depth of the housing of the deadlock ensures a particularly good transfer of forces between the handle and the deadlock and indirectly between the handle and the door. In this case, a depth of the housing is to be understood in particular as the extension of the housing over the door leaf, respectively the distance between a surface of the housing which abuts against the door leaf, and an exterior surface of the housing which is facing away from the door leaf. Such an inventive extension of the at least one support surface over the entire depth of the housing allows for ensuring a particularly good transfer of forces. Load on the material of the deadlock, in particular of the handle reception, and thus material fatigue linked thereto can be avoided. Thereby, a particularly long longevity of the inventive deadlock can be achieved.

According to another preferred embodiment of an inventive deadlock, it may be furthermore intended that the handle reception includes at least one support rib, which, for introducing the mechanical force into the housing of the deadlock, extends from the support surface to the housing of the deadlock. The housing of the deadlock forms in particular an exterior shell of the deadlock. Said shell is thus formed to be particularly stable and moreover, it is reliably connected to the door leaf. An inventive support rib thus allows particularly well for introducing a force from a handle into the housing, which the user exerted onto the latter via the support surface. Another increase in stability and robustness of an inventive deadlock is thereby achieved in relation to the utilization by a user, who intends to open, respectively to close the door.

Moreover, it may be intended in the inventive deadlock that the deadlock includes a cylinder reception for a locking cylinder, whereby a locking cylinder installed into the cylinder reception allows for actuating and/or blocking the dead bolt mechanics. The inventive deadlock is in particular configured in that an installed locking cylinder can be brought into operative connection with the dead bolt mechanics in such a way that the dead bolt can be moved into its opened position respectively into at least one locking position. In this case, different cylinder receptions for different locking cylinders, for example round cylinders or oval cylinders, may be provided. Such a locking cylinder which can be installed into the cylinder reception of an inventive deadlock allows in particular for locking/bolting the door. Moreover, a simple blocking mechanism of the door can thus help secure the door against unauthorized opening.

An inventive deadlock may be furthermore developed in that the dead bolt includes a dead bolt head and the dead bolt mechanics include a dead bolt interface, wherein the dead bolt head is releasably connected to the dead bolt interface. Thereby, in particular with the releasable connection, allowing to configure the dead bolt head to be exchangeable. On the one hand, the dead bolt head represents a part of the deadlock, which is exposed to highest loads. Exchanging a defective dead bolt head may thus extend the life span of the entire deadlock. This exchangeability likewise allows for equipping the same deadlock for different requirements with different dead bolt heads, for example made from different materials and/or with different dimensions. Thereby, a particularly large range of application options can be achieved for an inventive deadlock.

Moreover, an inventive deadlock may be further developed in that at least one steel pin, in particular a hardened steel pin, is disposed at and/or in the deadlock and/or at and/or in the dead bolt interface as burglar protection device. In this case, such a steel pin, as a burglar protection feature, may achieve for example sawing protection and/or a shearing protection features. In this case, such a steel pin is preferably disposed at and/or in the dead bolt head and/or at and/or in the dead bolt interface in that, if the dead bolt is located in its at least one locking position, it is located with one portion inside the dead bolt reception of the counter-part and with the second portion inside the housing of the deadlock. The steel pin extends in this manner from the inside of the housing of the deadlock into the dead bolt reception of the counter-part. A simple pushing open of such a secured door, which would be linked to shearing-off the dead bolt, can thereby be prevented. Likewise, simply sawing-off the dead bolt by means of a saw introduced into a door gap can be prevented, because the steel pin, which is preferably a hardened steel pin, will prevent such sawing. Thereby, another increased protection of a door locked with such an inventive deadlock can be achieved.

According to a second aspect of the invention, the problem is solved with a mounting method for an attaching disposition of a deadlock in a centered or at least essentially centered manner according to the first aspect of the invention at a long side of a door leaf of a door. An inventive mounting method is characterized by the following steps:
a) disposing the mounting interface of the deadlock in a centered or at least essentially centered manner at a long side of the door leaf, and
b) attaching the deadlock by means of the mounting interface of the deadlock at the door leaf.

Prior to performing step a) preparing the door leaf for the arrangement may be obviously performed. In this case, such a preparation may represent for example a surface treatment of the door leaf or else realizing a required single through-opening in the door leaf. Likewise the steps a) and b) may be performed one after the other or simultaneously. All in all, an inventive mounting method allows for equipping a door, in particular also an all-glass door with a middle lock, which is configured as a deadlock. As a result, in particular by utilizing an inventive deadlock according to the first aspect of the invention, any and all advantages described in conjunction with such an inventive deadlock according to the first aspect of the invention are provided for the mounting method.

### BRIEF DESCRIPTION OF THE DRAWINGS

In the following an inventive deadlock as well as an inventive mounting method and the advanced resulting advantages will be explained in detail based on the drawings. It is diagrammatically shown in:

FIG. 1 essential components of an inventive deadlock in an exploded illustration,

FIG. 2 essential components of an inventive deadlock in an assembled condition,

FIG. 3 a burglar protection device of an inventive deadlock, and

FIG. 4 an inventive deadlock at a door.

### DETAILED DESCRIPTION

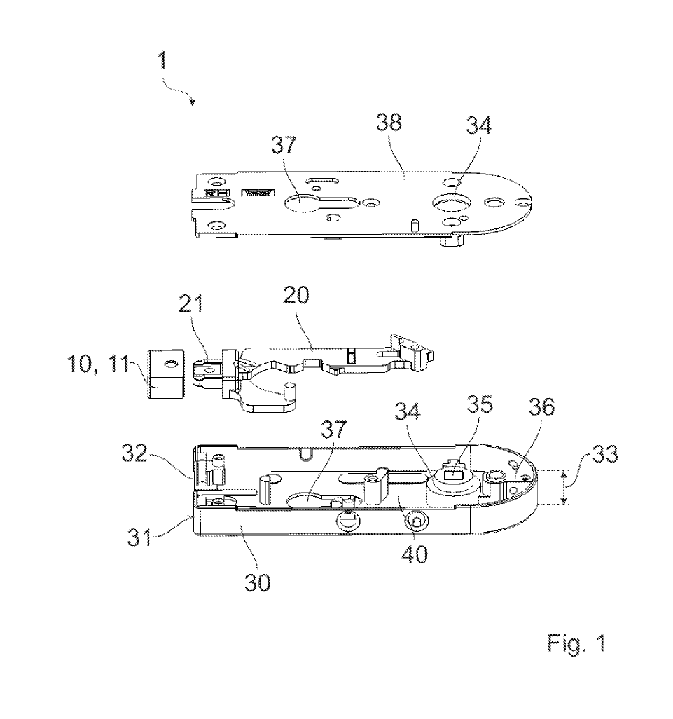

Elements having the same function and mode of operation are respectively identified by the same reference numerals in FIGS. 1 to 4.

FIG. 1 shows an inventive deadlock 1, wherein only the relevant structural components of the deadlock 1 are shown. Thus, in the embodiment shown, the inventive deadlock 1 includes a housing 30, the bottom plate thereof simultaneously forming the mounting interface 40. During the mounting operation of the deadlock 1, said mounting interface 40 is disposed in a centered or at least essentially centered manner at a long side 52 of the door leaf 51 of a door 50 (not illustrated here) and thus allows for an attaching disposition of the inventive deadlock 1 at said door 50, whereby the inventive deadlock 1 can be utilized as a middle lock. Dead bolt mechanics 20 are insertable into the housing 30. In this case, the dead bolt mechanics 20 include a dead bolt interface 21, at which the dead bolt head 11 of a dead bolt 10 can be releasably disposed. Such a releasable arrangement of a dead bolt head 11 at the dead bolt interface 21 of the dead bolt mechanics 20 allows for exchanging the dead bolt head 11, if required and/or to adapt the deadlock 1 to the application conditions of the deadlock 1. In this case, the dead bolt mechanics 20 are disposed in such a way in the housing 30 of the deadlock 1 that the dead bolt 10 is movable through a functional opening 32, which is disposed in a locking side 31 of the housing 30, from an opened position into at least one locking position 13 (not illustrated here). The housing 30 includes a cylinder reception 37 for the insertion of a locking cylinder 54 (not illustrated here). Obviously, it can be provided that the locking cylinder 54 can be brought into operative connection with the dead bolt mechanics 20 that, on the one hand, the movement of the dead bolt 10 can be realized by means of the locking cylinder 54 and, on the other hand, the dead bolt 10 can be arrested in both its opened position and in its at least one locking position 13. Obviously, for this purpose, the deadlock 1 can be disposed in such a way at a door 50 (not illustrated here), that the locking side 31 comes to bear against a long side 52 of the door leaf 51 of the door 50. It may be intended in particular according to the invention, that the housing 30 of the deadlock 1 includes only one functional opening 32, whereby the inventive deadlock 1 is a pure deadlock 1. Moreover, in this regard in the embodiment shown, the inventive deadlock 1 includes a handle reception 34. In this case, said handle reception 34 is connected in a torque-proof manner to the housing 30 and thus to the deadlock 1. A handle 53 (not illustrated here) disposed in the handle reception 34 is thereby able to replace a push handle. Thereby, further machining of the door 50, which would be required for the arrangement of such a push handle, can be saved. In this case, the handle reception 34 has a support surface 35, which is intended to absorb forces of the handle 53, which are generated when utilizing the handle 53 upon opening respectively closing the door 50. In the embodiment shown, said support surface 35 is configured in such a way that the handle reception 34 comprises a square reception. Thereby, it is possible with an inventive deadlock 1 to utilize standardized handles such as they are used for example also in latch locks. A particularly broad applicability of an inventive deadlock 1 can thus be achieved. The support surface 35 includes in particular a support surface 35 which corresponds to the depth 33 of the housing 30. A particularly good transfer of forces from the handle 53 via the support surface 35 into the housing 30 of the inventive deadlock 1 is thereby given. A load on the material of the deadlock 1 and thereby the risk of material fatigue can thus be at least reduced. Moreover, in the embodiment shown, a support rib 36 is provided, which extends from the support surface 35 of the handle reception 34 to the housing 30. Said support rib 36 is configured to directly divert forces, which act from the handle 53 onto the handle reception 34, into the housing 30. Thus, such a support rib 36 is likewise able to reduce load on the material by utilizing an inventive deadlock 1 as a push handle. Furthermore, lastly a cover 38 is shown which is intended for closing the housing 30 of the deadlock 1. Obviously, such a cover 38 includes likewise openings for the cylinder reception 37 and for the handle reception 34. Altogether an inventive deadlock 1 provides a fully functional pure deadlock 1 as a middle lock for any door 50, in particular also for all-glass doors.

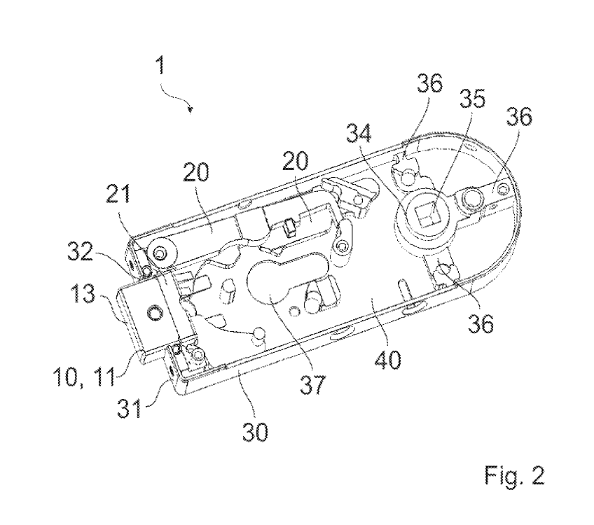

In FIG. 2, the structural components of an inventive deadlock 1 described in FIG. 1 are shown, wherein the cover 38 is not shown. The provided support ribs 36 are particularly well visible, which extend form the support surfaces 35 of the handle reception 34 to the proper housing 30 of the inventive deadlock 1. Independently of the direction of force exerted via a handle 53 (not illustrated here), which is disposed in the handle reception 34, said force is reliably diverted into the housing 30 of the deadlock 1. In the illustrated condition of an inventive deadlock 1, the dead bolt 10 is in its locking position 13. In said locking position 13, the dead bolt 10 and thereby likewise the dead bolt head 11 pass through the functional opening 32 in the locking side 31. In this case, it is preferably intended that the dead bolt 10 engages in a corresponding dead bolt reception of a counter-part 55 (not illustrated here) and thus, by means of a form closure, reliably prevents moving a door 50 (not illustrated here) at which the deadlock 1 is disposed. In this case, utilizing a deadlock 1, in contrast to a latch bolt lock, this circumstance can be achieved with a double-action door as well. It is particularly well visible that the functional opening 32 is the only functional opening 32 in the locking side 31. In this case, functional opening 32 according to the invention means that said function of the deadlock 1 is realized via said opening. Such a function comprises in this case for example in the movement of the dead bolt 10 from its opened position into its locking position 13. Further openings in the locking side 31, such as required for example for attachment elements such as screws, do not represent functional openings 32 according to the invention. It is likewise particularly well visible that in this embodiment of an inventive deadlock 1, the functional opening 32 is disposed centrally in the locking side 31. Thereby, it is possible to dispose an inventive deadlock 1 in different mounting positions at a door 50. In particular an inventive deadlock 1 can be intended for both left-locking and right-locking doors 50 as well as for both a pull-side and a push-side arrangement without having to alter the deadlock.

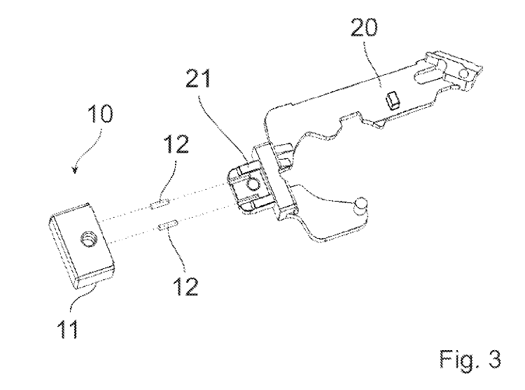

FIG. 3 shows one potential burglar protection device in an inventive deadlock 1. For this purpose, steel pins 12 may be provided at the dead bolt interface 21 of the dead bolt mechanics 20. In this case, said steel pins 12 may comprise in particular of hardened steel pins 12. By means of such disposed steel pins 12 at the dead bolt interface 21, the steel pins 12 are thereby automatically disposed in the dead bolt head 11 of the dead bolt 10 as well. After completing the assembly, which is indicated by the dashed lines, the steel pins 12 are thus located inside the dead bolt 10. In the locking position 13 (not illustrated here) of the dead bolt 10, the steel pins 12 preferably extend in such a way that with a first portion they are located within a dead bolt reception of a counter-part 55 (not illustrated here) and with a second portion they are located within the housing 30 (not illustrated here) of the deadlock 1. In the locking position 13 the steel pins 12 thus extend from the inside of the deadlock 11 to the inside of the counter-part 55. Simple shearing-off of the dead bolt 10 by pushing the door open can thus be reliably avoided. Likewise sawing-off the dead bolt 10 will fail due to said steel pins 12. Increasing the security when utilizing an inventive deadlock 1, in particular against unintended opening and/or against burglar attempts can be thereby achieved.

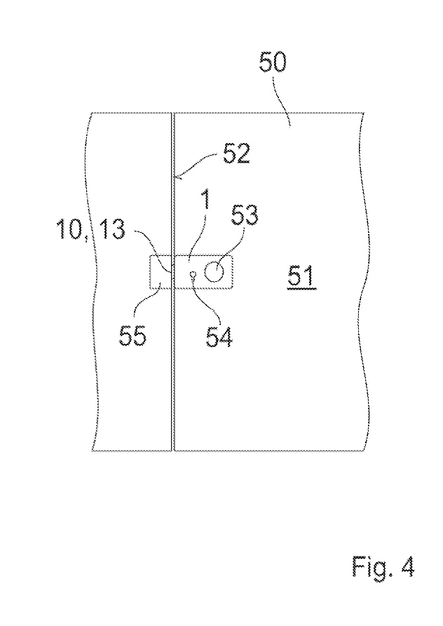

FIG. 4 shows a door 50 in which an inventive deadlock 1 is installed. In this case, the inventive deadlock 1 is disposed centrally at a long side 52 of the door leaf 51 of the door 50. The inventive deadlock 1 is thereby employed as a middle lock. Furthermore, a handle 53 is disposed at the inventive deadlock 1. Said handle 53 allows for moving the door 50 in the opened condition of the deadlock 1. An additional push handle, which would require additional machining of the door leaf 51 of the door, may thereby be foregone. This is particularly advantageous with all-glass doors, in which the door leaf 51 comprises a glass pane. Moreover, a locking cylinder 54 is inserted into the inventive deadlock 1. Such a locking cylinder 54, which inside the deadlock 1 can be brought into an operative connection with the dead bolt mechanics 20 (not illustrated here) is able to move the dead bolt 10. In the condition shown, the dead bolt 10 is located in its locking position 13. It is particularly well visible that in its locking position 13 the dead bolt 10 engages in a dead bolt reception of a counter-part 55. On account of said positive engagement moving the door 50 is reliably prevented. All in all, a middle lock for a door 50 is provided with the inventive deadlock 1, wherein the inventive deadlock 1 provides in particular the function of a push handle.

1. A deadlock for a door leaf of a door, in particular an all-glass door, comprising:
a housing,
a dead bolt,
dead bolt mechanics for moving the dead bolt between an opened position, in which the dead bolt is essentially disposed inside the housing, and at least one locking position, in which the dead bolt is at least partially disposed outside the housing,
a mounting interface configured for an attaching disposition of the deadlock in an essentially centered manner at a long side of the door leaf, and
a torque-proof handle reception for a handle.

2. The deadlock according to claim 1, wherein the mounting interface is configured for disposing and attaching the deadlock with a maximum of one through-opening in the door leaf.

3. The deadlock according to claim 1, wherein the housing of the deadlock includes a locking side, wherein the locking side includes one functional opening and wherein the dead bolt, when being moved between the opened position and the at least one locking position, can be moved through the functional opening.

4. The deadlock according to claim 3, wherein, for a disposition of the deadlock independently of the door type, the functional opening is disposed centrally in the locking side.

5. The deadlock according to claim 1, wherein the handle reception includes at least one support surface for the handle for transferring a mechanical force from the handle to the deadlock, and wherein the at least one support surface of the handle reception extends essentially over the entire depth of the housing of the deadlock.

6. The deadlock according to claim 1, wherein the handle reception includes at least one support rib for introducing the mechanical force into the housing of the deadlock and which extends from the support surface to the housing of the deadlock.

7. The deadlock according to claim 1, wherein the deadlock includes a cylinder reception for a locking cylinder, wherein the dead bolt mechanics can be operated and/or locked by means of a locking cylinder installed into the cylinder reception.

8. The deadlock according to claim 1, wherein the dead bolt includes a dead bolt head and the dead bolt mechanics include a dead bolt interface, wherein the dead bolt head is releasably connected to the dead bolt interface.

9. The deadlock according to claim 8, wherein at least one steel pin is disposed at and/or in the dead bolt head and/or at and/or in the dead bolt interface as a burglar protection device.

10. A mounting method for an at least essentially centered attaching disposition of a deadlock according to claim 1 at a long side of a door leaf of a door, comprising:
a) disposing the mounting interface of the deadlock in an at least essentially centered manner at a long side of the door leaf, and
b) attaching the deadlock by means of the mounting interface of the deadlock at the door leaf.
